(19) United States
(12) Patent Application Publication
(10) Pub. No.: US 2012/0292139 A1
(43) Pub. Date: Nov. 22, 2012

(54) BRAKE CONTROL DEVICE

(75) Inventors: Masatoshi HANZAWA, Kariya-shi (JP); Kentaro Yuasa, Tokai-shi (JP)

(73) Assignee: ADVICS CO., LTD., Kariya-shi (JP)

(21) Appl. No.: 13/472,973

(22) Filed: May 16, 2012

(30) Foreign Application Priority Data
May 16, 2011 (JP) 2011-109523

(51) Int. Cl. B60T 13/58; B60T 1/06

(52) U.S. Cl. 188/72.3

(57) ABSTRACT

There is provided a brake control device including a brake fluid pressure generation unit which generates a brake fluid pressure, a first wheel cylinder, a second wheel cylinder having a pressurization mechanism provided thereto, a control valve which is provided between the first wheel cylinder and the second wheel cylinder and keeps the brake fluid pressure of the first wheel cylinder, and a hold switching control unit which performs hold switching control of cutting off the control valve and thus keeping the brake fluid pressure in the first wheel cylinder when generating a braking force for stopping a vehicle by switching the second service braking force to the parking brake force.

### CROSS REFERENCE TO RELATED APPLICATIONS

This application is based on and claims priority under 35 U.S.C.§119 to Japanese Patent Application 2011-109523, filed on May 16, 2011, the entire content of which is incorporated herein by reference.

### BACKGROUND

1. Field of the Invention

The present invention relates to a brake control device which is applied to a vehicle brake system having a parking brake integrated pressurization mechanism in which a pressurization mechanism of an electric parking brake (EPB) and a wheel cylinder (hereinafter, referred to as W/C) of a service brake are integrated.

2. Description of Related Art

Regarding a vehicle brake system including a service brake (regular brake), which generates a brake fluid pressure in a W/C, based on a brake pedal operation of a driver, and thus generates a braking force, and a parking brake, which is mainly used to generate a braking force upon parking, JP-A-2007-509801 suggests a control method of stabilizing a vehicle using both the service brake and the parking brake. According to this control method, when keeping a stopped state of the vehicle by a brake force (hereinafter, referred to as service brake force) by the service brake, the brake force capable of keeping the stopped state of the vehicle is switched to a brake force (hereinafter, referred to as parking brake force) by the parking brake and then the service brake is released.

For example, in an active cruise control (hereinafter, referred to as ACC), when the vehicle is stopped by operating an electromagnetic valve of an actuator for brake fluid pressure control provided to the service brake or a motor for pump driving and thus generating a service brake force, the service brake force is thereafter switched to the parking brake force. Also, in a case where the vehicle is stopped on a slope road in association with a brake pedal operation of a driver, when the brake pedal operation of the driver is loosened and the service brake force is thus decreased, the service brake force is switched to the parking brake force so as to prevent the vehicle from draggingly going down by start assist control.

There is a limit on energization time and the like of the electromagnetic valve, which is driving time of the actuator for generating the service brake force, due to the durability. Compared to this, regarding the parking brake force, when a motor is once driven to generate the parking brake force, it is possible to keep the parking brake force even when the motor is not continuously driven. Thus, it is possible to stably keep the stopped state of the vehicle by switching the service brake force to the parking brake force while decreasing the driving time of the actuator for generating the service brake force.

However, regarding a vehicle brake system having a parking brake integrated pressurization mechanism in which a pressurization mechanism of an EPB and a W/C of the service brake are integrated, the inventors found that in a case where a brake fluid pressure pipe of the vehicle brake system has an X pipe configuration, when the brake force is switched from the service brake force to the parking brake force, the total brake force of the vehicle is decreased upon the switching. The problem is specifically described.

In the parking brake integrated pressurization mechanism, a pressurization piston which is moved based on a W/C pressure upon the service braking and a pressurization piston which is moved based on driving of a motor for parking brake are made to be common. Therefore, when switching the service brake force to the parking brake force, the motor for parking brake is driven to press the pressurization piston and to thus generate the parking brake force, in a situation where the service brake force is being generated by moving the pressurization piston, based on the W/C pressure. At this time, the pressurization piston is pushed by the driving of the motor for parking brake, so that a volume in the W/C is increased, compared to when only the service brake is operated. However, as the volume in the W/C is increased, the W/C pressure is decreased.

In general, the pressurization mechanism of the EPB is mounted on rear wheels of the vehicle, thereby generating the parking brake force for both rear wheels.

In the X pipe configuration, the W/Cs of a right front wheel and a left rear wheel are connected to a pipe path which supplies a brake fluid of a single brake fluid pressure and the W/Cs of a left front wheel and a right rear wheel are connected to a pipe path which supplies a brake fluid of a separate single brake fluid pressure. Therefore, when switching the service brake force into the parking brake force, as described above, the W/C pressures of the rear wheels to which the pressurization mechanism of the EPB is provided are decreased and the W/C pressures of the front wheels connected to the pipe path of the rear wheels are correspondingly decreased. Accordingly, the total brake force of the vehicle is decreased upon the switching, so that the vehicle may draggingly go down on the slope road or even when the brake is newly stepped as the vehicle draggingly goes down, a vehicle vibration may occur. In particular, it is general in the vehicle brake system that the larger brake force is generated for the front wheels, compared to the rear wheels. Thus, when the W/C pressures of the front wheels are decreased, the brake forces of the front and rear wheels are largely decreased.

In the meantime, there has been explained the case where the pressurization mechanism of the EPB is provided to both rear wheels. In general, the steering wheels of the vehicle are the front wheels and the non-steering wheels are the rear wheels. For a vehicle such as forklift, since the rear wheels are the steering wheels, the pressurization mechanism of the EPB is provided to the front wheels, in many cases. In this case, the pressurization mechanism of the EPB provided to the front wheels is operated to switch the service brake force to the parking brake force. However, for the X pipe, the similar problem also occurs.

### SUMMARY

The present invention has been made in view of the above circumstances, and an object of the present invention is to suppress a service brake force of a vehicle from being decreased as a pressurization mechanism of an EPB is operated when switching a service brake force to a parking brake force.

In order to achieve this objective, there is provided a brake control device comprising: a brake fluid pressure generation unit which generates a brake fluid pressure based on a brake operation of a driver; a first wheel cylinder which moves a first friction material to contact a first rubbed material and thus generate a first service braking force as a brake fluid pressure therein is increased, and which moves the first friction material in a direction separating away from the first rubbed material as the brake fluid pressure therein is decreased; a second wheel cylinder which moves a second friction material to contact a second rubbed material and thus generate a second service braking force as a brake fluid pressure therein is increased, and which moves the second friction material in a direction separating away from the second rubbed material as the brake fluid pressure therein is decreased; a pressurization mechanism which includes a pressing member provided in the second wheel cylinder, wherein as the pressing member is moved by an external force independent from the brake fluid pressure, the external force is applied to the second friction material, so that the second friction material is moved to contact the second rubbed material by the external force, thereby generating a parking brake force, and wherein the internal pressure in the second wheel cylinder is decreased by the moving of the pressing member; a pipe path which is connected to the first wheel cylinder and the second wheel cylinder and supplies a brake fluid having a single brake fluid pressure from the brake fluid pressure generation unit; a control valve which is provided on the pipe path between the first wheel cylinder and the second wheel cylinder and keeps the brake fluid pressure of the first wheel cylinder; and a hold switching control unit which performs hold switching control of cutting off the control valve and thus keeping the brake fluid pressure in the first wheel cylinder when generating a braking force for stopping a vehicle by switching the second service braking force to the parking brake force.

That is, the hold switching control unit performs the hold switching control of cutting off the control valve and thus keeping the brake fluid pressure in the first wheel cylinder when generating a braking force for stopping a vehicle by switching the second service braking force to the parking brake force in the second wheel cylinder having the pressurization mechanism provided thereto. Thereby, when switching the service brake force to the parking brake force, it is possible to prevent the first service brake force from being decreased in the first wheel cylinder even though the second service brake force is decreased in the second wheel cylinder. Hence, it is possible to suppress the vehicle vibration, which is caused due to the decrease of the total brake force of the vehicle, which is the sum of the service brake force and the parking brake force. Also, it is possible to enable the total brake force of the vehicle not to decrease less than the brake force capable of stopping the vehicle, so that it is possible to prevent the vehicle from draggingly going down on the slope road.

### BRIEF DESCRIPTION OF THE DRAWINGS

The foregoing and additional features and characteristics of this disclosure will become more apparent from the following detailed description considered with the reference to the accompanying drawing, wherein:

FIG. 1 is a schematic view showing an overall outline of a vehicle brake system to which a brake control device according to a first illustrative embodiment of the present invention is applied;

FIG. 2 is a sectional schematic view of a brake mechanism of a rear wheel system provided to the brake system;

FIG. 3 is a fluid pressure circuit diagram of the brake system, which shows a detailed configuration of an actuator 7;

FIGS. 4A and 4B are sectional views showing operating states of the brake mechanism of the rear wheel system before and after the switching;

FIG. 5 is a flow chart of hold switching control; and

FIG. 6 is timing charts showing changes in brake force when the hold switching control is performed and when the hold switching control is not performed.

### DETAILED DESCRIPTION

Hereinafter, illustrative embodiments of the present invention will be described with reference to the drawings. Meanwhile, in the illustrative embodiments, the same or equivalent parts are indicated by the same reference numerals in the drawings.

### First Illustrative Embodiment

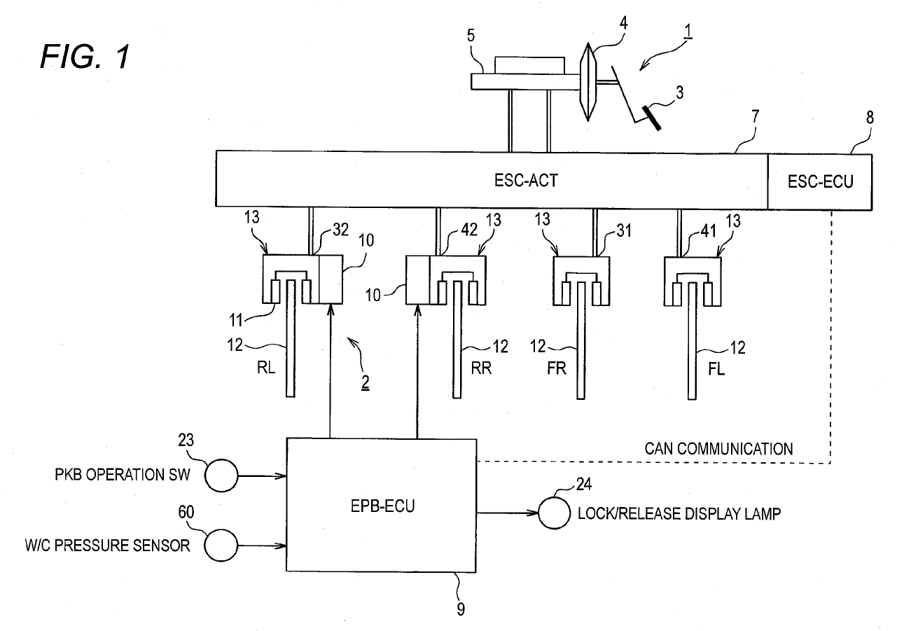

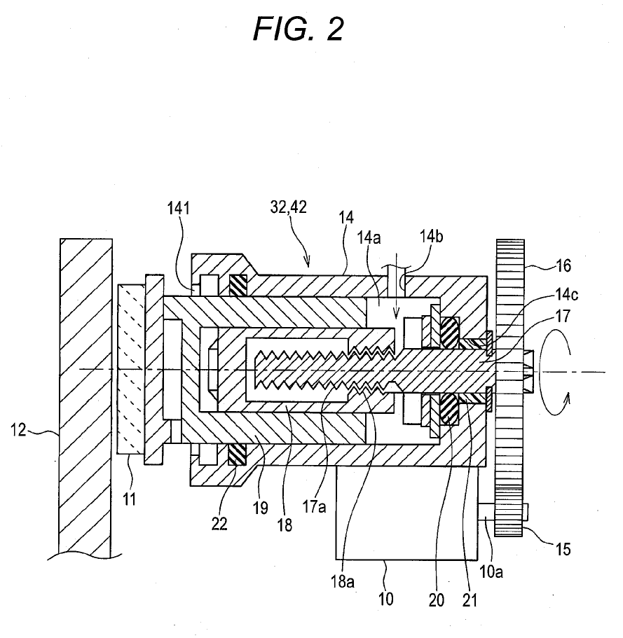

A first illustrative embodiment of the present invention is described. In this illustrative embodiment, a vehicle brake system having an X pipe configuration in which a disc brake type EPB is applied to a rear wheel system is exemplified. FIG. 1 is a schematic view showing an overall outline of a vehicle brake system to which a brake control device according to this illustrative embodiment is applied. Also, FIG. 2 is a sectional schematic view of a brake mechanism of a rear wheel system provided to the brake system. In the below, the illustrative embodiment is described with reference to FIGS. 1 and 2.

As shown in FIG. 1, the brake system has a service brake 1 which generates a braking force based on a pedaling force of a driver and an EPB 2 which restrains a vehicle from moving upon parking.

The service brake 1 boosts a pedaling force, which is generated as the driver steps on a brake pedal 3, by a booster 4, generates a brake fluid pressure corresponding to the boosted pedaling force in a master cylinder (hereinafter, referred to as M/C) 5 and transmits the brake fluid pressure to respective W/Cs 31, 32, 41, 42 provided to brake mechanisms of respective wheels, thereby generating a braking force. In this illustrative embodiment, the brake pedal 3, the booster 4 and the M/C 5 are an example of a brake fluid pressure generation unit. Also, an actuator 7 which is the brake fluid pressure adjusting unit is provided between the M/C 5 and the W/Cs 31, 32, 41, 42, adjusts the braking force which is generated by the service brake 1 and performs a variety of controls (for example, anti-skid control and the like) for improving safety of a vehicle.

The various controls using the actuator 7 are executed by an ESC (Electronic Stability Control)—ECU 8. For example, a control current for controlling a variety of control valves or motor for pump driving provided to the actuator 7 is output from the ESC-ECU 8, thereby controlling a fluid pressure circuit provided to the actuator 7 and thus controlling the W/C pressures to be transmitted to the W/Cs 31, 32, 41, 42. A detailed configuration of the actuator 7 will be described later.

In the meantime, the EPB 2 is controlled by an EPB control device (hereinafter, referred to as EPB-ECU), drives a motor 10 by the EPB-ECU 9 and controls the brake mechanism, thereby generating a braking force.

In the brake system of this illustrative embodiment, the brake mechanism has a mechanical configuration which generates the braking force. The brake mechanism of a front wheel system has a configuration which generates the braking force by an operation of the service brake 1. However, the brake mechanism of a rear wheel system has a shared configuration which generates the braking force by both an operation of the service brake 1 and an operation of the EPB 2. Since the brake mechanism of the front wheel system is a brake mechanism in which a mechanism for generating the braking force based on the operation of the EPB 2 is removed from the brake mechanism of the rear wheel system and that has been conventionally used, the description thereof is omitted here. That is, in the below, the brake mechanism of the rear wheel system is described.

In the brake mechanism of the rear wheel system, not only when the service brake 1 is operated but also when the EPB 2 is operated, brake pads 11 which are friction materials shown in FIG. 2 are pressed and a brake disc 12 which is a material to be rubbed (rubbed material) is sandwiched by the brake pads 11, so that a frictional force is generated between the brake pads 11 and the brake disc 12 and thus the braking force is generated. That is, the brake mechanism is a parking brake integrated pressurization mechanism in which the pressurization mechanism of the EPB 2 and the W/Cs 32, 42 of the service brake are integrated.

The pressurization mechanism of the EPB 2 is configured by the motor 10, a spur gear 15, a spur gear 16, a rotational shaft 17 and a propeller shaft 18. By the pressurization mechanism, a parking brake force is generated. Specifically, when operating the EPB 2, the brake mechanism rotates the motors 10, which are directly fixed to bodies 14 of the W/Cs 32, 42 for pressing the brake pads 11 as shown in FIG. 2, in calipers 13 shown in FIG. 1. Then, the brake mechanism rotates the spur gear 15 provided to a driving shaft 10a of the motor 10 and thus transmits the rotational force of the motor 10 to the spur gear 16 engaged to the spur gear 15, thereby moving the brake pads 11 and thus generating the brake force by the EPB 2.

In the caliper 13, a part of an end face of the brake disc 12 is accommodated such that it is sandwiched between the brake pads 11, in addition to the W/C 32, 42 and the brake pads 11. Each of the W/Cs 32, 42 is configured to generate the W/C pressure in a hollow part 14a, which is a brake fluid accommodation chamber, by introducing a brake fluid pressure into the hollow part 14a of the cylindrical body 14 through a passage 14b, and is provided in the hollow part 14a with the rotational shaft 17, the propeller shaft 18, the piston 19 and the like. The body 14 has a cylinder shape having a bottom and a bottom surface thereof is located at an opposite side to the brake pad 11, and an opening 141 is provided at a side of the brake pad 11. The opening 141 is plugged by the piston 19.

The rotational shaft 17 has an end which is connected to the spur gear 16 through an insertion hole 14c formed at the body 14. When the spur gear 16 is rotated, the rotational shaft 17 is rotated in association with the rotation of the spur gear 16. An end portion of the rotational shaft 17, which is at an opposite side to the end portion connected to the spur gear 16, is formed with a male thread recess 17a on an outer periphery of the rotational shaft 17. In the meantime, the other end of the rotational shaft 17 is inserted and supported in the insertion hole 14c. Specifically, the insertion hole 14c is provided with an O-ring 20 and a bearing 21. The O-ring 20 prevents the brake fluid from leaking between the rotational shaft 17 and an inner wall surface of the insertion hole 14c. The bearing 21 supports the other end of the rotational shaft 17.

The propeller shaft 18 is configured by a hollow cylinder member and is formed on an inner wall surface thereof with a female thread recess 18a which is screwed to the male thread recess 17a of the rotational shaft 17. The propeller shaft 18 has a circular cylinder shape or polygonal column shape having a key for rotation prevention, so that it is not rotated about a rotational center of the rotational shaft 17 even when the rotational shaft 17 is rotated. Hence, when the rotational shaft 17 is rotated, the rotational force of the rotational shaft 17 is converted into a force moving the propeller shaft 18 in an axial direction of the rotational shaft 17 due to the engagement of the male thread recess 17a and the female thread recess 18a. When the driving of the motor 10 is stopped, the propeller shaft 18 is adapted to stop at the same position by the frictional force due to the engagement of the male thread recess 17a and the female thread recess 18a. Also, when a target braking force is obtained and the driving of the motor 10 is thus stopped at that time, the propeller shaft 18 can be kept at the corresponding position.

The piston 19 is arranged to surround the outer periphery of the propeller shaft 18, is configured by a circular cylinder member or polygonal cylinder member having a bottom and is arranged such that an outer periphery thereof abuts on the inner wall surface of the hollow part 14a of the body 14. A seal member 22 is provided on the inner wall surface of the body 14 so as to prevent the brake fluid from leaking between the outer periphery of the piston 19 and the inner wall surface of the body 14 and has a configuration capable of applying the W/C pressure to the end face of the piston 19. The seal member 22 is a member which is used to generate a reactive force for restoring the piston 19 upon release control after lock control.

In a case where the propeller shaft 18 is provided with a key for rotation prevention such that it is not rotated about a rotational center of the rotational shaft 17 even when the rotational shaft 17 is rotated, the piston 19 is formed with a key recess in which the key slides. When the propeller shaft 18 has a polygonal column shape, the piston has a corresponding polygonal cylinder shape.

The brake pad 11 is disposed at a tip end of the piston 19. As the piston 19 is moved, the brake pad 11 is moved in the left-right direction on the paper sheet. Specifically, the piston 19 has an outer periphery which abuts on the inner wall surface of the hollow part 14a of the body 14, and can be moved leftward on the paper sheet as the propeller shaft 18 is moved. Also, as the W/C pressure is applied to the end portion of the piston 19 (the end portion opposite to the end portion at which the brake pad 11 is disposed), the piston can be moved leftward on the paper sheet independently of the propeller shaft 18. When the brake fluid pressure in the hollow part 14a is not applied (W/C pressure=zero (0)) at a state where the propeller shaft 18 is located at an initial position (a state before the motor 10 is rotated), the piston 19 is moved rightward on the paper sheet, thereby separating the brake pad 11 from the brake disc 12. Also, when the W/C pressure becomes zero (0) while the motor 10 is rotated and thus the propeller shaft 18 is being moved leftward from the initial position on the paper sheet, the rightward moving of the piston 19 is restrained by the propeller shaft 18 being moved, so that the brake pad 11 is kept at the corresponding position.

In the brake mechanism configured as described above, when the service brake 1 is operated, the piston 19 is moved leftward on the paper sheet, based on the W/C pressure generated by the operation, so that the brake pads 11 are pressed to the brake disc 12 and the braking force is thus generated. Also, when the EPB 2 is operated, the motor 10 is driven, so that the spur gear 15 is rotated and the spur gear 16 and the rotational shaft 17 are correspondingly rotated. Hence, the propeller shaft 18 is moved toward the brake disc 12 (the left direction on the paper sheet) based on the engagement of the male thread recess 17a and the female thread recess. Accompanied by this, the piston 19 is also moved in the same direction, so that the brake pads 11 are pressed to the brake disc 12 and the braking force is thus generated. Accordingly, it is possible to provide the shared (common) brake mechanism of the service brake 1 and the EPB 2, which is the parking brake integrated pressurization mechanism capable of generating the braking force in response to both the operation of the service brake 1 and the operation of the EPB 2.

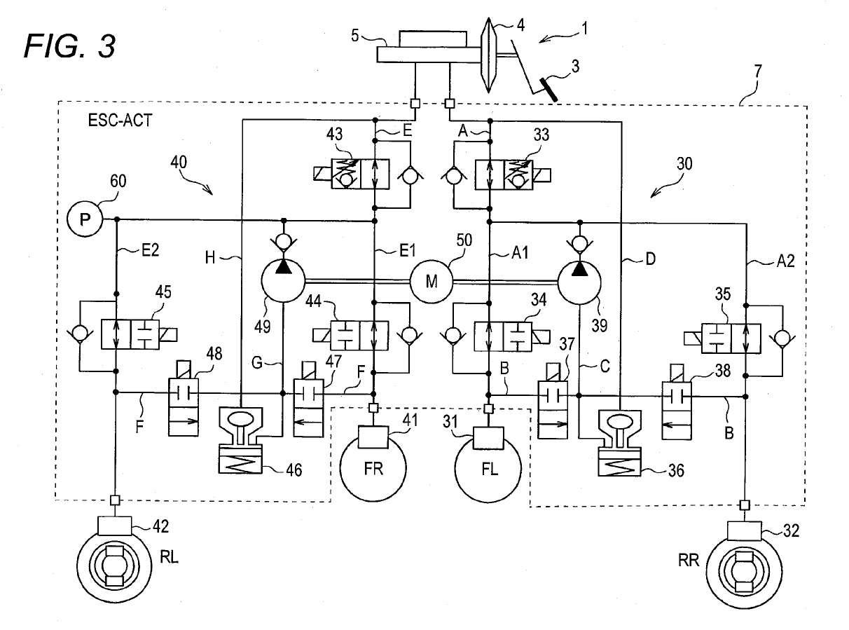

In the below, a detailed configuration of the actuator 7 is described with reference to FIG. 3 showing a fluid pressure circuit diagram of the brake system, which shows a detailed configuration of the actuator 7.

As shown in FIG. 3, first and second pipe systems 30, 40 which communicate with a primary chamber and a secondary chamber of the M/C 5, respectively, are configured in the actuator 7. The first pipe system 30 controls the brake fluid pressure which is applied to the left front wheel FL and the right rear wheel RR, and the second pipe system 40 controls the brake fluid pressure which is applied to the right front wheel FR and the left rear wheel RL. That is, the X pipe configuration is provided.

The M/C pressure which is generated in the M/C 5 when generating the service braking force is transmitted to the respective W/Cs 31, 32, 41, 42 through the first pipe system 30 and the second pipe system 40. The first pipe system 30 is provided with a pipe path A which connects the primary chamber of the M/C 5 and the W/Cs 31, 32, and the second pipe system 40 is provided with a pipe path E which connects the secondary chamber of the M/C 5 and the W/Cs 41, 42. Through the respective pipe paths A, E, the M/C pressure is transmitted to the W/Cs 31, 32, 41, 42.

Also, the pipe paths A, E are provided with differential pressure control valves 33, 43 capable of controlling the pipe paths into a communication state and a differential pressure state. Valve positions of the differential pressure control valves 33, 43 are adjusted such that the communication state is made upon the service brake where the driver operates the brake pedal 3. When the current flows in solenoid coils of the differential pressure control valves 33, 43, the valve positions are adjusted such that the larger the current value, the larger differential pressure state is made.

When the differential pressure control valves 33, 43 are at the differential pressure state, the brake fluid is permitted to flow from the W/Cs 31, 32, 41, 42 to the M/C 5 only when the brake fluid pressures of the W/Cs 31, 32, 41, 42 are higher than the M/C pressure by a predetermined amount. Therefore, a state is kept in which the W/Cs 31, 32, 41, 42 are always higher than the M/C 5 by a predetermined pressure.

The pipe paths are branched into two pipe paths A1, A2, E1, E2, respectively, at sides of the W/Cs 31, 32, 41, 42, which are downstream from the pipe paths A, E and the pressure control valves 33, 43. The pipe paths A1, E1 are provided with first pressure boost control valves 34, 44 which control the boosting of the brake fluid pressure to the W/Cs 31, 41, and the pipe paths A2, E2 are provided with second pressure boost control valves 35, 45 which control the boosting of the brake fluid pressure to the W/Cs 32, 42.

The first and second pressure boost control valves 34, 35, 44, 45 are configured by two-position electromagnetic valves capable of controlling communication/cut-off states. The first and second pressure boost control valves 34, 35, 44, 45 are normal open types which are controlled into the communication state when the control current flowing in solenoid coils of the first and second pressure boost control valves 34, 35, 44, 45 become zero (non-energization state) and are controlled into the cut-off state when the control current flows in the solenoid coils (energization state).

The intervals between the first and second pressure boost control valves 34, 35, 44, 45 and the respective W/Cs 31, 32, 41, 42 on the pipe paths A, E are connected to pressure regulating reservoirs 36, 46 through pipe paths B, F functioning as pressure reduction pipe paths. The pipe paths B, F are respectively provided with first and second pressure reduction control valves 37, 38, 47, 48 which are configured by two-position electromagnetic valves capable of controlling the communication/cut-off states. The first and second pressure reduction control valves 37, 38, 47, 48 are normal close types which are controlled into the cut-off state when the control current flowing in solenoid coils of the first and second pressure reduction control valves 37, 38, 47, 48 become zero (non-energization state) and are controlled into the communication state when the control current flows in the solenoid coils (energization state).

Pipe paths C, G which are reflux pipe paths are provided between the pressure regulating reservoirs 36, 46 and the pipe paths A, E which are main pipe paths. The pipe paths C, G are provided with self-priming pumps 39, 49 which suction/discharge the brake fluids from the pressure regulating reservoirs 36, 46 toward the M/C 5 or W/Cs 31, 32, 41, 42 and are driven by a motor 50. The motor 50 is driven by control on energization to a motor relay (not shown).

Pipe paths D, H which are auxiliary pipe paths are provided between the pressure regulating reservoirs 36, 46 and the M/C 5. The pumps 3, 49 suction the brake fluid from the M/C 5 through the pipe paths D, H and discharge the brake fluid to the pipe paths A, E, thereby supplying the brake fluid to the W/Cs 31, 32, 41, 42.

The actuator 7 is configured as described above. The ESC-ECU 8 outputs a control current for controlling the various control valves 33 to 35, 37, 38, 43 to 45, 47, 48 and the motor 50 for pump driving, thereby controlling the fluid pressure circuit provided to the actuator 7. Thereby, it is possible to prevent the wheel lock by reducing, keeping or boosting the W/C pressure, as the anti-skid control, upon the wheel slipping that is caused upon braking, or to suppress the sideslip tendency (under-steer tendency or over-steer tendency) by automatically pressurizing the W/C pressure of the control target wheel, as the sideslip prevention control, and to thus perform the rotating of an ideal trajectory. Also, as the ACC control, it is possible to generate the braking force by automatically pressurizing the W/C pressures of the respective wheels such that a vehicle interval with a front vehicle can be kept at a constant interval corresponding to the vehicle speed, and to stop the own vehicle when the front vehicle is stopped.

In the meantime, although not shown, the ESC-ECU 8 is input with detection signals from wheel speed sensors which are provided to the respective wheels of the vehicle. Based on the detection signals of the wheel speed sensors, respective wheel speeds, estimated vehicle speed, a slip ratio and the like are calculated. The ESC-ECU 8 executes the anti-skid control and the like, based on the calculation results. Also, the actuator 7 is provided with a W/C pressure sensor 60. The EPB-ECU 9 is input with a detection signal of the W/C pressure sensor 60, so that the W/C pressure is monitored by the EPB-ECU 9.

The EPB-ECU 9 is configured by a known microcomputer having a CPU, a ROM, a RAM, an I/O and the like and controls the rotation of the motor 10 according to a program stored in the ROM and the like, thereby performing the parking brake control such as lock/release control. In this illustrative embodiment, the EPB-ECU 9 also performs hold switching control (which will be described later), based on the information from the ESC-ECU 8, and configures an electronic control unit. For example, the EPB-ECU 9 inputs a signal and the like corresponding to an operation state of an operation switch (SW) 23 provided to an instrument panel (not shown) in a cabin and drives the motor 10 according to the operation state of the operation SW 23. Also, the EPB-ECU 9 outputs a signal indicative of a lock state or release state to a lock/release display lamp 24 provided to the instrument panel, depending on the driving state of the motor 10.

Specifically, the EPB-ECU 9 has a variety of function units for executing the lock/release control, such as a motor current detection of detecting the current (motor current) flowing in the motor 10 at an upstream or downstream side of the motor 10, a target motor current calculation of calculating a target motor current (target current value) upon terminating the lock control, a determination of determining whether the motor current reaches the target motor current, a control on the motor 10 based on the operation state of the operation SW 23, and the like. The EPB-ECU 9 positively rotates or reverses the motor 10 or stops the rotation of the motor 10, based on the state of the operation SW 23 or motor current, thereby performing the control of locking/releasing the EPB 2.

The vehicle brake system configured as described above performs an operation in which the braking force is generated for the vehicle by generating the service brake force by the service brake 1 when the vehicle is running and an operation in which when the vehicle is stopped by the service brake 1, the driver pushes the operation SW 23 to operate the EPB 2 and to thus generate the parking brake force and the stopped state is thus kept. That is, in the operation of the service brake 1, when the driver steps on the brake pedal while the vehicle is running, the brake fluid pressure generated in the M/C 5 is transmitted to the W/Cs 31, 32, 41, 42, so that the service brake force is generated. Also, in the operation of the EPB 2, the motor 10 is driven to move the piston 19 and the brake pads 11 are thus pressed to the brake disc 12, so that the parking brake force is generated.

Also, it is possible to operate the actuator 7 provided to the service brake 1, thereby executing the anti-skid control for preventing the wheel lock. Also, by operating the actuator 7, it is possible to drive the motor 50 at a state where the differential pressure control valve 33, 34 are controlled into the differential pressure state, thereby automatically pressurizing the respective W/Cs 31, 32, 41, 42. Therefore, by using the automatic pressurizing function, it is possible to perform the sideslip prevention control of suppressing the sideslip tendency and enabling the rotation of the ideal trajectory or to perform the ACC control of keeping the vehicle interval with the front vehicle at a constant interval corresponding to the vehicle speed, even without the brake pedal operation by the driver.

Also, in the operation of the EPB 2, even when the driver does not push the operation SW 23, it is possible to perform the start assist control of generating the parking brake force so as to prevent the vehicle from draggingly going down on the slope road.

That is, by using the vehicle brake system of this illustrative embodiment, it is possible to perform the various controls. In some of those controls, by switching the service brake force into the parking brake force, it is possible to perform the hold switching control of stably keeping the stopped state of the vehicle while attempting to reduce the driving time of the actuator for generating the service brake force. For example, when the ACC control is performed to stop the vehicle, it is possible to switch the service brake force into the parking brake force, or when performing the start assist control, it is possible to switch the lowering of the service brake force due to the brake pedal operation by the driver to the parking brake force. Upon the switching, the W/C pressure is lowered, as described above.

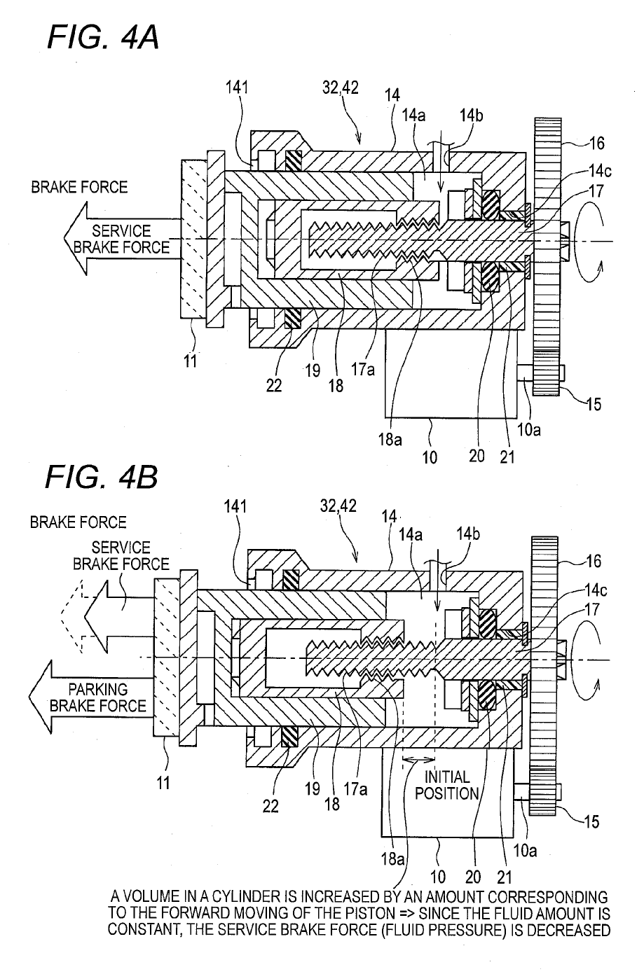

FIGS. 4A and 4B are sectional views showing operating states of the brake mechanism of the rear wheel system before and after the switching. The service brake force is switched to the parking brake force, based on the brake pedal operation of the driver or by operating the EPB 2 from a state where the service brake force is being generated by the automatic pressurizing function of the actuator 7 and thus generating the parking brake force. The service brake force is generated by supplying the brake fluid into the hollow part 14a of the W/C 32, 42 through the passage 14b formed in the body 14, moving the piston 19 toward the brake disc 12, as shown in FIG. 4A, and thus pressing the brake pads 11 to the brake disc 12. Since the parking brake force is generated at this state, the motor 10 of the EPB 2 is operated to further move the piston 19 to the brake disc 12, as shown in FIG. 4B.

In the meantime, since the service brake force is being generated at any state of FIGS. 4A and 4B, the brake pads 11 are pressed to the brake disc 12. However, when the force of moving the piston 19 to the brake disc 12 more strongly is applied, the piston 19 is moved to the brake disc 12 by elastic deformation of the brake pads 11 and the like even at a state where the brake pads 11 are being pressed to the brake disc 12.

Thus, as shown in FIG. 4B, a volume of the hollow part 14a of the body 14 is changed by an amount corresponding to the forward moving of the piston 19 before and after the piston 19 is moved. Meanwhile, since the amount of the brake fluid being supplied to the hollow part 14a is not changed, the W/C pressure is decreased due to the change in the volume of the hollow part 14a. Also, as the W/C pressures of the rear wheel system are decreased, the W/C pressures of the front wheel are also decreased due to the X pipe configuration. Hence, the total brake force of the vehicle, which is a sum of the service brake force and the parking brake force, is deceased upon the switching, so that the vehicle vibration may occur or the vehicle may draggingly go down on the slope road. The decrease of the W/C pressures of the front wheels, which is caused in association with the decrease of the W/C pressures of the rear wheel system, occurs regardless of whether the brake fluid is continuously supplied to the W/Cs based on the automatic pressurizing function of the service brake 1. That is, although the brake fluid can be supplied into the W/C by the automatic pressurizing function, the supply of the brake fluid is dependent on the responsiveness of the pressurization and the response of the pressurization is later than the decrease of the W/C pressure, so that it is difficult to solve the problem of the decrease of the W/C pressure.

However, in this illustrative embodiment, when switching the service brake force to the parking brake force, the hold switching control of operating and thus cutting off the pressure boost control valves 34, 44 of the front wheels and keeping the W/C pressures of the front wheel system even when the W/C pressures of the rear wheel system are decreased is performed. That is, by keeping the W/C pressures of the front wheel system, it is possible to cause the service brake force to decrease only in the rear wheel system. At the same time, it is possible to prevent the total brake force of the parking brake force and the service brake force from being decreased or to minimize the decrease even when the total brake force is decreased.

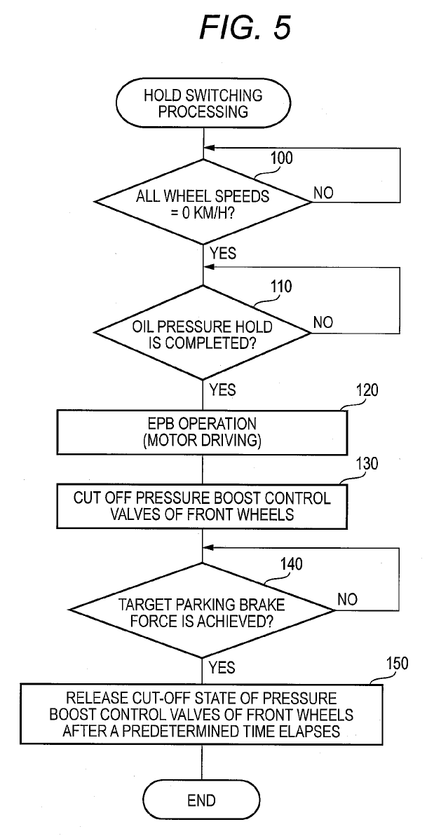

FIG. 5 is a flow chart of the hold switching control which is performed by the vehicle brake system according to this illustrative embodiment. In the below, the hold switching control is specifically described with reference to FIG. 5. The EPB-ECU 9 executes the processing every predetermined control period, based on the information from the ESC-ECU 8 and detection signal of the W/C pressure sensor 60 when the control of switching the service brake force to the parking brake force, such as ACC control or start assist control, is executed.

First, in step 100, it is determined whether all the wheel speeds are 0 km/h. Thereby, it is determined whether the vehicle is stopped. This processing is executed as the information about the respective wheel speeds is acquired from the ESC-ECU 8. Here, when a result of the determination is affirmative, the processing proceeds to step 110. Otherwise, this processing is iterated.

In step 110, it is determined whether oil pressure hold has completed. The completion of the oil pressure hold means a state where the oil pressure reaches a target W/C pressure. For example, it means that the oil pressure reaches a target W/C pressure when the vehicle is stopped based on the automatic pressurizing function, in the ACC control or that the oil pressure reaches a target W/C pressure capable of preventing the vehicle from draggingly going down on the slope road, in the start assist control. In the meantime, since the ACC control or start assist control is generally executed by the ESC-ECU 8, this processing is executed when the EPB-ECU 9 acquires the information about the target W/C pressure of the ACC control or start assist control from the ESC-ECU 8.

When a result of the determination in step 110 is affirmative, the processing proceeds to step 120. Then, the motor 10 starts to drive, so that the EPB 2 operates. At the same time, the processing proceeds to step 130 in which the pressure boost control valves 34, 44 of the front wheels are switched to the cut-off state, and then proceeds to step 140. Thereby, the service brake force is switched to the parking brake force. At the same time, the pressure boost control valves 34, 44 of the front wheels are switched to the cut-off state, so that it is possible to prevent the service brake force of the front wheel system from being decreased.

After that, in step 140, it is determined whether the target parking brake force is achieved. When a result of the determination is affirmative, the processing proceeds to step 150 in which the cut-off state of the pressure boost control valves 34, 44 of the front wheels is released and returned to the communication state after a predetermined time elapses, so that the service brake force is released. Thereby, it is possible to generate the desired braking force only by the parking brake force.

The target parking brake force is a brake force which can keep the stopped state of the vehicle, and is required in the ACC control or start assist control. For example, in the ACC control, the target parking brake force is a target W/C pressure when stopping the vehicle. In the start assist control, the target parking brake force is a target W/C pressure corresponding to a gradient of the slope road. The parking brake force which is being generated can be estimated by a value of the current flowing in the motor 10. When the parking brake force which is being generated reaches the target parking brake force, an affirmative determination is made.

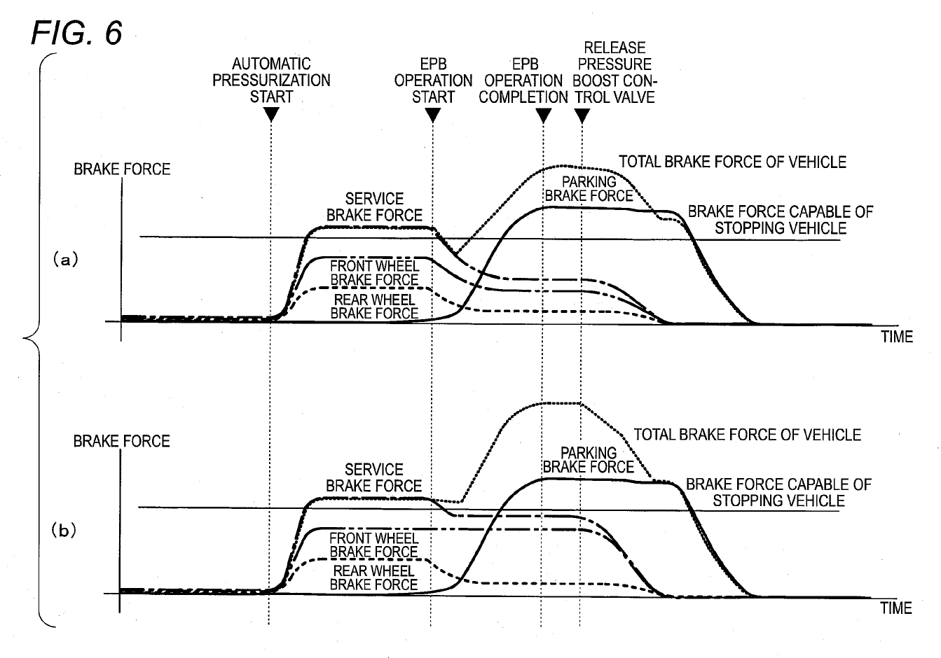

Accordingly, the hold switching control is completed. FIG. 6 is timing charts showing changes in brake force when the hold switching control is performed and when the hold switching control is not performed.

As shown in (a) of FIG. 6, when the hold switching control is not performed, both the front wheel brake force and the rear wheel brake force by the service brake 1 are decreased simultaneously with the switching to the parking brake force, and the service brake force, which is the sum of the front wheel brake force and the rear wheel brake force, is decreased. In this case, the total brake force of the vehicle, which is the sum of the service brake force and the parking brake force, is more decreased than the brake force capable of stopping the vehicle, so that the vehicle vibration may occur or the vehicle may draggingly go down on the slope road.

However, as shown in (b) of FIG. 6, when the hold switching control is performed, the rear wheel brake force is decreased but the front wheel brake force is not decreased upon the switching to the parking brake force. Therefore, it is possible to suppress the vehicle vibration, which is caused due to the decrease of the total brake force of the vehicle, which is the sum of the service brake force and the parking brake force, and to enable the total brake force of the vehicle not to decrease less than the brake force capable of stopping the vehicle. Hence, it is possible to prevent the vehicle from draggingly going down on the slope road.

Here, the timing at which the cut-off state of the pressure boost control valves 34, 44 is released to release the service brake force is timing after the target parking brake force is achieved and then a predetermined time elapses. However, the timing may be timing upon the achievement of the target parking brake force or may be set depending on user's tastes or maker's desires. For example, when the timing is timing after a predetermined time elapses, it is possible to differentiate generation timing of an operating sound of the EPB 2 and generation timing of a sound due to the release of the service brake force. There is a desire that a sound should not be generated at another part while the EPB 2 is being operated. By differentiating the generation timing of the sounds, it is possible to cope with the desire. To the contrary, if the sound due to the release of the service brake force is generated upon the generation of the operating sound of the EPB 2, it is possible to overlap the sounds and to thus assimilate the sounds to some extent. Therefore, it may be preferable to set the release timing of the service brake force depending on the user's tastes or maker's desires.

As described above, in this illustrative embodiment, the parking brake integrated pressurization mechanism in which the service brake 1 and the EPB 2 are integrated in the rear wheel system is adopted. Also, in the vehicle brake system of the X pipe configuration, the pressure boost control valves 34, 44 of both the front wheels are cut off to keep the front wheel brake force when switching the service brake force to the parking brake force. Thereby, when switching the service brake force to the parking brake force, it is possible to prevent the front wheel brake force from being decreased even though the rear wheel brake force is decreased. Hence, it is possible to suppress the vehicle vibration, which is caused due to the decrease of the total brake force of the vehicle, which is the sum of the service brake force and the parking brake force, and to enable the total brake force of the vehicle not to decrease less than the brake force capable of stopping the vehicle. Therefore, it is possible to prevent the vehicle from draggingly going down on the slope road.

### Other Illustrative Embodiments

(1) In the above illustrative embodiment, the case where the pressurization mechanism of the EPB 2 is provided to both the rear wheels has been exemplified. That is, in general, the steering wheels of the vehicle are the front wheels and the non-steering wheels are the rear wheels. For a vehicle such as forklift, since the rear wheels are the steering wheels, the pressurization mechanism of the EPB 2 is provided to the front wheels, in many cases. In this case, the pressurization mechanism of the EPB 2 provided to the front wheels is operated to cut off the pressure boost control valves 35, 45 of the rear wheels which are the non-steering wheels when switching the service brake force to the parking brake force. Thereby, it is possible to obtain the same effects as the above illustrative embodiment.

Also, the pressurization mechanism of the parking brake may be provided to the steering wheels, in some vehicles. Also in this case, it is possible to obtain the same effects as the above illustrative embodiment by cutting off the pressure boost control valves 35, 45 of the non-steering wheels that are the wheels to which the EPB is not mounted.

Also, in a vehicle in which the pressurization mechanism is provided to all four wheels, when switching the service brake force to the parking brake force by operating the pressurization mechanism of the specific wheels, the pressure boost control valves 35, 45 of the wheels different from the specific wheels, which are connected by the pipe paths of the specific wheels, are cut off, so that it is possible to obtain the same effects as the above illustrative embodiment.

Also, when switching the service brake force to the parking brake force by operating the pressurization mechanism of the specific wheels, the pressure boost control valves 35, 45 of the specific wheels are cut off, so that it is possible to prevent the service brake force of the wheels different from the specific wheels, which are connected by the pipe paths of the specific wheels, from being decreased. As a result, it is possible to obtain the same effects as the above illustrative embodiment.

(2) In the above illustrative embodiment, the disc brake has been exemplified. However, regarding the other brake mechanism such as drum brake, the present invention can be also applied to the brake system having the parking brake integrated pressurization mechanism in which the service brake 1 and the pressurization mechanism of the EPB 2 are integrated. Also, in the above illustrative embodiment, the EPB-ECU 9 has been exemplified as the electronic control unit. However, the present invention is not limited thereto. For example, in the above illustrative embodiment, the configuration having the ESC-ECU 8 and the EPB-ECU 9 has been exemplified as the control device. However, the ESC-ECU and the EPB-ECU may be integrated to configure the electronic control unit or the electronic control unit may be implemented by the other ECU. That is, regarding the brake system having the service brake 1 and the EPB 2, the present invention may have a configuration, other than the above configuration, insomuch as the electronic control unit realizes the switching from the service brake force to the parking brake force in the brake system having the parking brake integrated pressurization mechanism.

For example, the EPB 2 may be configured to generate the parking brake force by moving the friction material such as brake pads 11 and the pressing member such as piston 19 having the friction material attached thereto in a direction, along which the friction material is brought into contact with the material to be rubbed (rubbed material) such as brake disc 12, with the moving member such as propeller shaft 18. Also, the service brake 1 has the brake fluid pressure generation unit which generates the brake fluid pressure, based on an operation of the brake operation member such as brake pedal 3 by the driver, the WCs 31, 32, 41, 42 which are connected to the brake fluid pressure generation unit and the actuator 7 which is arranged therebetween and configures the brake fluid pressure regulation unit capable of performing the automatic pressurization of the W/C pressure. When pressurization the W/C, the EPB 2 and the common pressing member are pressed by the brake fluid pressure in the direction along which the friction material is moved toward the material to be rubbed. As a result, the service brake force is generated.

In the meantime, when a drum brake is adopted as the brake mechanism, the friction material and the material to be rubbed (rubbed material) are a brake shoe and a drum, respectively.

What is claimed is:

1. A brake control device comprising:
a brake fluid pressure generation unit which generates a brake fluid pressure based on a brake operation of a driver;
a first wheel cylinder which moves a first friction material to contact a first rubbed material and thus generate a first service braking force as a brake fluid pressure therein is increased, and which moves the first friction material in a direction separating away from the first rubbed material as the brake fluid pressure therein is decreased;
a second wheel cylinder which moves a second friction material to contact a second rubbed material and thus generate a second service braking force as a brake fluid pressure therein is increased, and which moves the second friction material in a direction separating away from the second rubbed material as the brake fluid pressure therein is decreased;
a pressurization mechanism which includes a pressing member provided in the second wheel cylinder, wherein as the pressing member is moved by an external force independent from the brake fluid pressure, the external force is applied to the second friction material, so that the second friction material is moved to contact the second rubbed material by the external force, thereby generating a parking brake force, and wherein the internal pressure in the second wheel cylinder is decreased by the moving of the pressing member;
a pipe path which is connected to the first wheel cylinder and the second wheel cylinder and supplies a brake fluid having a single brake fluid pressure from the brake fluid pressure generation unit;
a control valve which is provided on the pipe path between the first wheel cylinder and the second wheel cylinder and keeps the brake fluid pressure of the first wheel cylinder; and
a hold switching control unit which performs hold switching control of cutting off the control valve and thus keeping the brake fluid pressure in the first wheel cylinder when generating a braking force for stopping a vehicle by switching the second service braking force to the parking brake force.

2. The brake control device according to claim 1,
wherein the hold switching unit releases the cut-off state of the control valve after a target parking brake force is achieved and then a predetermined time elapses.

3. The brake control device according to claim 1,
wherein the hold switching unit releases a cut-off state of the control valve at a same time as when a target parking brake force is achieved.
